(19) United States
(12) Patent Application Publication
(10) Pub. No.: US 2026/0225344 A1
(43) Pub. Date: Aug. 6, 2026

(54) SHEET CONTAINING A FOAM LAYER AND A THERMOPLASTIC ELASTOMER

(71) Applicants: TMG - TECIDOS PLASTIFICADOS E OUTROS REVESTIMENTOS PARA A INDUSTRIA AUTOMOVEL, S.A., SAO COSME DO VALE (PT); THE HAARTZ CORPORATION, ACTON, MA (US)

(72) Inventors: Goncalo CAMPOS DE ARAUJO MESQUITA DA SILVEIRA, SAO COSME DO VALE (PT); Maria Ines BARBOSA LIMA DA COSTA, SAO COSME DO VALE (PT); Ruben OLIVEIRA PEREIRA, SAO COSME DO VALE (PT); Jose Antonio RIBEIRO FERREIRA, SAO COSME DO VALE (PT); Srinivas P. SITARAM, ACTON, MA (US); Mark G. HELDER, ACTON, MA (US)

(21) Appl. No.: 19/149,617

(22) PCT Filed: Jun. 21, 2024
(86) PCT No.: PCT/EP2024/067498

§ 371 Date: Jul. 21, 2025

(30) Foreign Application Priority Data
Jun. 28, 2023 (PT) 118762

(51) Int. Cl. B32B 5/24; B32B 5/18; B32B 7/09; B32B 27/08; B32B 37/14

(52) U.S. Cl. CPC B32B 5/245; B32B 5/18; B32B 7/09; B32B 27/08; B32B 37/14; B32B 2250/03; B32B 2262/062; B32B 2274/00; B32B 2307/7376; B32B 2605/00

(57) ABSTRACT

A sheet contains a support layer, an intermediate layer arranged on the support layer, and a cover layer arranged on the intermediate layer. The cover layer is a compact layer, the intermediate layer is a foam layer or contains a foam layer, and the intermediate layer and/or the cover layer contains a thermoplastic elastomer.

The support layer is directly bonded to the intermediate layer and no adhesive layer is arranged between the support layer and the intermediate layer. The sheet or a sewn product from the sheet is used as a material for the interior of a vehicle.

### FIELD OF THE INVENTION

The present invention relates to a sheet comprising a support layer, an intermediate layer, and a cover layer, wherein the cover layer is a compact layer, the intermediate layer consists of or contains a foam layer, and the compact layer and/or the foam layer contains a thermoplastic elastomer, a method of preparing the sheet, and the use of the sheet as a material such as an artificial leather used in the interior of a vehicle.

### BACKGROUND ART

EP 3 766 687 A1 and EP 3 533 601 A1 disclose a composite structure containing a foam layer, a textile layer, and a compact cover layer in the indicated order and containing a thermoplastic elastomer. The composite structure is soft and flexible and suitable for the use in the interior of a vehicle. WO 2019/042610 A1 discloses a composite structure comprising a textile layer, a foam layer, and a compact cover layer as a soft and flexible material for use as cover material in a vehicle.

### Problem to Be Solved by the Invention

In view of the state of the art, the problem underlying the present invention was to provide a structure having improved properties in terms of low weight, low wrinkle formation, softness, and flexibility to achieve good handling during processing such as sewing.

### SUMMARY OF THE INVENTION

The problem underlying the present invention was solved by providing the sheet according to the present invention.

The present application covers the following preferred aspects.

[1] A sheet comprising a support layer, an intermediate layer arranged on the support layer, and a cover layer arranged on the intermediate layer, wherein the cover layer is a compact layer, the intermediate layer is a foam layer or contains a foam sublayer, and at least one of the intermediate layer and the cover layer contains a thermoplastic elastomer, wherein the support layer is directly bonded to the intermediate layer and no adhesive layer is arranged between the support layer and the intermediate layer. [1-1] The sheet according to aspect [1], wherein the cover layer is directly bonded to the intermediate layer.

[1-2] The sheet according to any of the preceding aspects, wherein the layers contained in the intermediate layer are directly bonded to each other and the layers contained in the cover layer are directly bonded to each other.

[1-3] A combination of aspect [1-1] and [1-2] is preferred.

[1-4] The sheet according to any of the preceding aspects, wherein the foam layer or the foam sublayer has a density of less than 800 kg/m³, preferably less than 650 kg/m³, more preferably less than 500 kg/m³.

[1-5] The sheet according to any of the preceding aspects, wherein the total of the support layer, the intermediate layer, and the cover layer has a density of less than 800 kg/m³, preferably less than 650 kg/m³.

[1-6] The sheet according to any of the preceding aspects, wherein the sheet can be folded to form a double-layer structure, in which two B-sides of the sheet are layered on each other and contact each other at the folding edge, and the double-layer structure can be unfolded to its initial state, wherein the sheet preferably shows no visible damage or change at the folding edge after folding and unfolding.

[1-7] The sheet according to any of the preceding aspects, wherein the sheet is suitable for preparing a sewn product obtainable by sewing the sheet.

[1-8] The sheet according to any of the preceding aspects, wherein the sheet is suitable for preparing a sewn product obtainable by sewing at least two parts of the sheet, wherein the two parts belong to the same sheet or to different sheets; and the sewn product is preferably obtainable by folding the sheet, placing the A-side or B-side surfaces of two parts of the sheet together to provide a contact area, and sewing the sheet in the contact area.

[1-9] The sheet according to any of the preceding aspects, wherein the sheet shows no damages and no changes after 100,000 flexing cycles in a test according to DIN 53 351.

[1-10] The sheet according to any of the preceding aspects, wherein the cover layer composition has a Shore A hardness according to DIN 53505 of less than 90.

[1-11] The sheet according to any of the preceding aspects, wherein the sheet has a tear propagation force according to DIN EN ISO 4674-1 of 10 to 50 N in a first direction and a second direction perpendicular to the first direction.

[1-12] The sheet according to any of the preceding aspects, wherein the cover layer or a lacquer layer that coats the cover layer and has a thickness of less than 40 μm is the uppermost layer of the sheet.

[1-13] The sheet according to any of the preceding aspects, wherein at least one of the intermediate layer and the cover layer consists of at least two sublayers.

[1-14] The sheet according to any of the preceding aspects, wherein the intermediate layer consists of two sublayers and the cover layer is single layer, or wherein the intermediate layer is a single layer and the cover layer consists of two sublayers. [2] The sheet according to any of the preceding aspects, wherein the intermediate layer contains or consists of a compact sublayer and a foam sublayer.

[2-1] The sheet according to aspect [2], wherein either the compact sublayer or the foam sublayer is arranged on the support layer.

[2-2] The sheet according to any of the preceding aspects, wherein the sublayer that is directly bonded to the support layer has a thickness of more than 0.1 mm, preferably at least 0.15 mm.

[3] The sheet according to any of the preceding aspects, wherein the foam layer or the sublayer of the intermediate layer that is directly bonded to the support layer (i.e., either the foam layer in case the intermediate layer is a foam layer, or the lowermost layer of the intermediate layer in case the intermediate layer contains a foam sublayer) contains a thermoplastic elastomer.

[3-1] The sheet according to aspect [3], wherein the intermediate layer contains or consists of a compact sublayer and a foam sublayer, wherein either the compact sublayer or the foam sublayer is directly bonded to the support layer and contains a thermoplastic elastomer.

[3-2] The sheet according to a combination of aspects [3-1] and [2-2].

[4] The sheet according to any of the preceding aspects, wherein the foam layer or each sublayer of the intermediate layer contains a thermoplastic elastomer.

[5] The sheet according to any of the preceding aspects, wherein the foam layer or each sublayer of the intermediate layer contains a thermoplastic elastomer and wherein the cover layer contains a thermoplastic elastomer.

[5-1] The sheet according to any of the preceding aspects, wherein all sublayers of the intermediate layer and the cover layer contain a thermoplastic elastomer.

[5-2] The sheet according to any of the preceding aspects, wherein the content of the thermoplastic elastomer in a layer is at least 50 %.

[5-3] The sheet according to any of the preceding aspects, wherein the content of the thermoplastic elastomer in the total of the intermediate layer and the cover layer is at least 30 %, preferably at least 50 %.

[5-4] The sheet according to any of the preceding aspects, wherein the content of the thermoplastic elastomer in each of the sublayers of the intermediate layer and the cover layer is at least 30 %, preferably at least 50 %.

[6] The sheet according to any of the preceding aspects, wherein the support layer contains or consists of a textile layer, wherein the textile layer preferably contains one or more kinds of fibers selected from the group consisting of polyester, polyolefin, polyamide, polyurethane, and cotton or other natural fibers.

[6-1] The sheet according to any of the preceding aspects, wherein the support layer is a textile layer. [6-2] The sheet according to a combination of aspects [1-5] and [6-1]. [6-3] The sheet according to a combination of aspects [6-2] and [5-3]. [6-4] The sheet according to a combination of aspects [6-2] and [1-6], preferably [6-3] and [1-6]. [6-5] The sheet according to a combination of aspects [6-1] and [4].

[7] The sheet according to any of aspects [6] to [6-5], wherein the textile layer of the support layer is directly bonded to the intermediate layer.

[8] The sheet according to any of aspects [6] to [6-5], wherein the sheet contains a compound structure consisting of only a part of the textile layer and only a part of the intermediate layer interpenetrating each other.

[8-1] The sheet according to aspect [8], wherein extent of intermediate layer interpenetration, as defined herein, is 5 % to 90 %.

[8-2] The sheet according to aspect [8-1], wherein the extent of intermediate layer interpenetration is less than 50 %, preferably less than 20 %.

[9] The sheet according to any of aspects [6]to [8-2], wherein the extent of textile layer interpenetration, as defined herein, is 5 % to 90 %.

[9-1] The sheet according to aspect [9], wherein the extent of textile layer interpenetration is less than 50 %, preferably less than 20 %.

[9-2] The sheet according to a combination of aspects [8-2] and [9-1].

[10] The sheet according to any of the preceding aspects, wherein the support layer is a textile layer having a thickness of 0.1 to 2.0 mm, the intermediate layer has a thickness of 1.0 to 5.0, and the cover layer has a thickness of 0.1 mm to 1.5 mm.

[11] The sheet according to any of the preceding aspects, wherein the sheet is an artificial leather.

[12] A method of preparing the sheet as described in any of aspects [1] to [11], comprising thermally or thermo-mechanically bonding the support layer, the intermediate layer, and the cover layer.

[12-1] The method according to aspect [12], wherein the compound structure is formed in a bonding step, in which the intermediate layer composition or at least a part of a film made of the intermediate layer composition is in molten form and the support layer is in non-molten form, or wherein the intermediate layer composition or at least a part of a film made of the intermediate layer composition is in molten form and at least a part of the support layer is in molten form.

[12-2] The method according to aspect [12] or [12-1], wherein the process of bonding the intermediate layer and the support layer comprises applying pressure and thermal treatment in a single step.

[13] A sewn product obtainable by sewing the sheet according to any of aspects [1] to [11].

[14] A method of preparing a sewn product comprising sewing a sheet according to any of aspects [1] to [11].

[15] The use of a sheet as described in any of aspects [1] to [11] or a sewn product according to aspect [13] as a material in the interior of a vehicle, preferably for seating applications.

### Advantages of the Invention

The sheet according to the invention is a low-weight, soft, and flexible material. It exhibits low wrinkle formation when bent. These properties make the sheet easy to handle and, in particular, facilitate sewing. A further advantage is the easy recyclability of the sheet when the material of the layers is selected from the same compound family.

Compared to prior art sheets containing a foam layer at the B-side of the textile layer, the sheet according to the present application, in particular the cover layer, can be made thinner since there is no risk that the textile layer is visible through the cover layer. In addition, the properties of the foam layer such as the softness are not affected by a textile layer arranged on the foam layer. Hence, the haptic properties of the sheet according to the present application can be improved and textile layer may be selected independent of the requirements such as the softness of the foam layer.

### Embodiments of the Invention

The sheet of the present invention contains a support layer, an intermediate layer, and a cover layer as mandatory layers.

The intermediate layer is arranged on the support layer and the cover layer is arranged on the intermediate layer. Herein, the term “arranged on” means that the layers are directly bonded to each other, i.e., they are directly layered on each other without any material such as an adhesive layer in between. A direct bonding of the cover layer to the intermediate layer is preferred. Likewise, the sublayers of the intermediate layer and sublayers of the cover layer are preferably directly bonded to each other.

The support layer is arranged at the B-side and the cover layer is arranged at the A-side of the sheet. Herein, the terms “A-side” and “B-side” either refer to the sheet as a whole or to an individual layer, and the terms “above” and “below” the sheet or a layer denote a position at the A-side and the B-side, respectively, of the sheet or layer. The sheet is a layer structure itself. The B-side of the sheet may contain any additional structure, such as a carrier layer or any other layer or functional structure.

Herein, the terms “the sheet”, “the support layer”, “the intermediate layer”, and “the cover layer” refer to “the sheet according to the present invention”, “the support layer contained in the sheet according to the present invention”, “the intermediate layer contained in the sheet according to the present application”, and “the cover layer contained in the sheet of the present invention”, respectively, unless explicitly stated otherwise.

The sheet is preferably flexible and elastic and can preferably be folded reversibly, i.e., folded from an initial state and then unfolded to its initial state. Preferably, the sheet can be folded to form a double-layer structure, in which two B-sides of the sheet are layered on each other and contact each other at the folding edge, and the double-layer structure can be unfolded to its original state. Preferably, the sheet, in particular the folding edge, shows no visible damage or change such as crease whitening after folding and unfolding. The visible damage or change mentioned herein may be measured at room temperature in accordance with the criteria described in DIN 53 351.

Preferably, the sheet is suitable for preparing a sewn product obtainable by sewing at least two sheets or two parts of the same sheet. The sewn product may be prepared by folding the sheet, placing two B-side parts of the sheet together to form a contact area and sewing the two parts of the sheet in the contact area. For the sheet to have the desired properties, e.g. easy processability when sewing, the sheet must not be too hard. The hardness of the sheet is therefore preferably less than 30 Shore D, and more preferably less than 90Shore A. For suitability for sewing, it is also important that the sheet has a suitable stitch tear-out force. This is preferably at least 40 N according to DIN EN ISO 23910. In one embodiment, the sheet is both suitable as a tearable coating for an airbag cover without a material weakening and suitable for preparing a sewn product obtainable by sewing at least two layers of the sheet.

The sheet is flexible and preferably shows no damages and changes after 100,000 flexing cycles, more preferably after 1,000,000 flexing cycles in a test according to DIN 53 351.

The intermediate layer and cover layer may show elastic properties and/or thermoplastic properties. The thermoplastic property allows thermal bonding of the layers without the use of an adhesive. The thermoplastic property requires that the overall degree of crosslinking is not too high. The gel content is preferably 0 % to 20 %.

In the present invention, a compact layer is defined by having a density of higher than 800 kg/m³, and a foam layer is defined by having a density of less than 800 kg/m³.

The support layer, the intermediate layer, and the cover layer are preferably bonded to each other without the use of an adhesive. This structure may be formed exclusively by thermal bonding. Preferably, the support layer is not melted at the temperature used in the thermal bonding. In the case of a connection exclusively based on thermal bonding, the connection is reversible, and the layers can be separated from each other at room temperature or by heating to melt the layer(s) at least partly. The connection of the layers may be enforced by treating the sheet e.g. with irradiation or electron beams from the B-side of the support layer to form chemical bonds between the layers. In that case, the connection between the layers is not reversible, i.e., the layers cannot be separated by at least partly melting the cover layer. Thermal bonding of a textile layer as the support layer and the intermediate layer may result in interpenetrated layers. Preferably, a full interpenetration is excluded, and both the intermediate layer and the textile layer have a non-interpenetrated layer part in the thickness direction. As a result, the textile layer is not exposed at the surface of the intermediate layer surface and thus does not affect the appearance of the sheet, and the textile layer not fully penetrated with the intermediate layer material is still flexible.

In the present invention, the thickness of the intermediate layer is defined as the thickness of the compound structure plus the thickness of the part of the intermediate layer not being part of the compound structure. Similarly, the thickness of the textile layer is defined as the thickness of the compound structure plus the thickness of the part of the textile layer not being part of the compound structure. As a result, the thickness of the sheet may be the total of the thicknesses of the raw material layers minus the thickness of the compound structure. In the present invention, the thickness of a layer or structure in the sheet may be determined by preparing a cross-section perpendicular to the layer plane of the sheet and observing the cross-section using a microscope. The thickness of the layer or structure is the average thickness obtained by determining the thicknesses within a range of at least 10 mm of the length of said layer or structure.

The sheet may contain an additive such as a filler, plasticizer, a flame retardant, a color pigment, a stabilizer, a lubricant, an ultraviolet absorber, a light stabilizer, an antioxidant, an antibacterial agent, and a foaming agent. The additive may be independently contained in the textile layer and/or the intermediate layer and/or the cover layer.

The sheet according to the present invention may be opaque or translucent. Generally, a translucent structure allows the transmittance of more visible light than an opaque structure when light is emitted from the same light source.

The cover layer may be coated with a lacquer layer. The lacquer may be a conventional material. The thickness of the lacquer layer may preferably be 1 to 30 μm, more preferably 3 to 10 μm. The lacquer layer is applied directly on top of the cover layer as a finish of the sheet and a protection against chemical agents, physical damage such as scratches or abrasion, and UV radiation. Conventional lacquers used for artificial leather for the interior of vehicles can be employed, such as a lacquer layer based on a silicone-containing aliphatic polyurethane. The lacquer layer usually consists of one or more, preferably up to four, transparent layers of lacquer. Alternatively, the surface coating may be coloured by adding colour pigments.

An adhesive may be used in the present invention to bond layer structures to each other. The adhesive may be a polyolefinic adhesive, a polyurethane adhesive, an acrylic adhesive, or a hot melt adhesive based on polyurethane (PUR). The adhesive may be used in a thickness of less than 40 μm.

In the present invention, the terms “comprises,” “comprising,” “including,” and “having,” are inclusive and therefore specify the presence of stated features, steps, layers and/or components, but do not preclude the presence or addition of one or more other features, steps, layers, components, and/or groups thereof. The method steps, processes, and operations described herein are not to be construed as necessarily requiring their performance in the particular order discussed or illustrated, unless specifically identified as an order of performance. It is also to be understood that additional steps may be employed.

Whenever it is mentioned in the context of this description that individual compositions or layers are based on or made of a certain material, this should be interpreted as the respective material forming the main constituent of the composition or layer, wherein other constituents may also be present in small quantities. In embodiments, the terms “based on” or “made of” a certain material means a content of more than 50 %, preferably 90 %, and more preferably 95 %.

As used herein, the singular forms “a,” “an,” and “the” may be intended to include the plural forms as well, unless the context clearly indicates otherwise. For instance, layers and components are generally described in the singular form, e.g. “a” layer or “containing a” layer. Such singular form formulations are meant to include more than one of the indicated component or layer, unless indicated otherwise.

The term “and/or” includes any and all combinations of one or more of the associated listed items. Percentages (%) of contents of components are percentages by mass (% by mass) unless explicitly indicated otherwise. Likewise, “parts” are parts by mass.

The standards and norms mentioned herein refer to the latest version available at the time this application was filed, unless indicated otherwise.

### Support Layer

The sheet contains a support layer which may be made of any flexible material such as a polymer film, a foam layer, or a textile layer. Preferably, the support layer consists of a textile layer. The textile layer preferably has a thickness of 0.1 to 3.0 mm, more preferably 0.1 to 2.0 mm.

Examples of a textile layer are knitted fabrics, woven textiles, non-woven textiles, glass fiber textiles, spunlace, or a spacer fabric. A knitted fabric is a flexible material made by creating an interlocking bundle of yarns or threads, which are produced by spinning raw fibers into long and twisted lengths. The basic constituents of the textile layer, i.e., the filaments, fibers, yarns, threads etc., are herein jointly referred to as fibers. A spacer fabric is a flexible material formed of two surface textile layers held by spacer threads in a defined spacing. The textile layer is not compact and comprises a large volume ratio of hollow spaces that are usually filled with air.

The density of the textile layer is preferably 100 to 500 kg/m³, more preferably 100 to 300 kg/m³. The textile layer may contain or consist of one or more kinds of fibers selected from the group consisting of polyester, polyolefin such as polyethylene or polypropylene, polyurethane, polyamide, cotton and natural fibers.

### Intermediate Layer

The intermediate layer consists of or contains a foam layer. In the latter case, the intermediate layer contains at least two layers, i.e., sublayers, one of which being the foam layer and either of which can be arranged on the support layer. The sublayers are preferably directly bonded to each other.

The composition of the foam layer is not restricted. The foam layer may consist of or contain PVC foam, TPE based foams, PUR based foams and/or EVA/EMA foams. Preferably, the foam layer consists of or contains polyolefin foam. The foam layer contains polypropylene foam (PP foam) in a preferred embodiment. Polypropylene (PP) is understood here to be such polymers or copolymers whose weight proportion of propylene is >50 %. The foam layer may contain common additives, such as lubricants, stabilizers, fillers, such as inorganic fillers, and/or pigment. The foam may be produced by first sheet extrusion, followed by crosslinking and then expansion.

The foam layer may have a thickness of 0.5 to 10 mm. Preferably, the thickness of the foam layer is 1.0 to 5.0 mm. The density of the foam layer or a foam sublayer is preferably lower than 500 kg/m³, preferably in the range from 30 to 300 kg/m³, more preferably 30 to 150 kg/m³ and even more preferably 40 to 100 kg/m³. The higher the density of the foam, the higher is its strength. The gel content mentioned herein is measured according to ASTM D 2765-16. A sample is weighed (initial weight) and placed in xylene for 24 hours at 180° C., the dissolved material is separated and the weight of the remaining material is determined (final weight); gel content [%]=[(final weight)/(initial weight)]×100 %. The foam layer may be prepared by known methods and may be foamed using chemical blowing agents, expandable microspheres, and/or physical blowing agents.

In addition to the foam layer contained in the intermediate layer, a foam layer may be contained in the support layer or at the B-side of the sheet.

A compact layer that is optionally contained in the intermediate layer may be made of the polymer material described in relation to the cover layer.

### Cover Layer

The sheet contains or consists of a compact cover layer. In the former case, the cover layer contains at least two compact layers, i.e., sublayers. The sublayers are preferably directly bonded to each other.

The layer(s) of the cover layer may be made of or contain any polymer material such as polyolefin, polyvinyl chloride, or polyurethane in addition to the optional thermoplastic elastomer. The polyolefin may be a thermoplastic polyolefin (TPO). Examples of TPO are polyethylene (PE) and polypropylene (PP). Polyethylene (PE) is defined here as polymers or copolymers whose proportion by weight of ethylene is more than 50 % by weight.

Polypropylene (PP) is defined here as polymers or copolymers whose proportion by weight of propylene is more than 50 % by weight. Examples of TPO are blends of polyethylene (PE) and polypropylene (PP). Examples of PE are HDPE, LDPE and LLDPE.

The cover layer preferably has a thickness of 0.05 mm to 2.0 mm, more preferably 0.1 mm to 1.5 mm. The density of the compact cover layer or a compact sublayer is higher than 800 kg/m³ and preferably higher than 850 kg/m³.

The cover layer may contain usual additives such as plasticizers, stabilizers, anti-aging agent (e.g. antioxidants), fillers and pigments (silica, TiO₂, CaCO₃, Mg(OH)₂, carbon black, mica, kaolin, clay, coal dust, lignin, talc, BaSO₄, Al(OH)₃, ZnO, and MgO), flame retardants (e.g. antimony trioxide or zinc hydroxystannate), waxes, colorants, compatibilizers and other auxiliary substances (e.g. viscosity aids, adhesion promoters, etc.). An example of an additive is a UV stabiliser which may be selected from one or more members of the group consisting of benzotriazole or hindered amine light stabilizers.

The cover layer preferably has a grain, which is a three-dimensionally structured surface on the top side covered with lacquer. The grain may be present in the cover layer only or both in the cover layer and the lacquer layer. The sheet having a grain may be used as an artificial leather. The depth of the grain is less than the thickness of the cover layer and is preferably 10 to 500 μm, more preferably 50 to 300 μm. The grain can be produced using conventional methods.

### Thermoplastic Elastomer

A thermoplastic elastomer (TPE) is contained in the intermediate layer and/or the cover layer.

A TPE is defined as an elastomer showing thermoplastic behaviour. The term “thermoplastic” denotes polymers or polymer compositions showing thermoplastic properties, in particular thermoreversibility. TPE behaves rubber-elastically in the range of usual service temperatures. TPE is a copolymer or an elastomer alloy, i.e., a physical mix of polymers that consists of materials with both thermoplastic and elastomeric properties. Copolymers are statistical copolymers or block copolymers, which consist of a main polymer such as polyethylene, whose degree of crystallization is reduced to a certain extent by a randomly incorporated comonomer such as vinyl acetate. In block copolymers, the hard and soft segments in a molecule are sharply separated (e.g. SBS, SIS). Copolymers can therefore consist of a soft elastomer and a hard thermoplastic component. Elastomer alloys are blends of finished polymers. The desired properties can be obtained by varying the mixing ratios.

Generally, there are the following generic classes of TPEs (designations according to ISO 18064): Styrenic block copolymer (TPS), thermoplastic polyolefin elastomer (TPO), thermoplastic vulcanizate (TPV), thermoplastic polyurethane (TPU), thermoplastic copolyester (TPC), melt processing rubbers, and thermoplastic polyamide (TPA).

The TPE used in the present invention may belong to one generic class or may be a blend of TPEs from two or more classes. Also, the TPE may be selected from one class and may be one kind of TPE of one class or a blend of two or more kinds of TPEs of one class. The content of TPE in the intermediate layer and/or the cover layer is preferably at least 50 %. The total content of thermoplastic polymers, i.e., TPE and other thermoplastic polymers, in the intermediate layer and/or the cover layer is preferably at least 80 %, more preferably at least 90 %. Preferably, the total content of polymers in the intermediate layer and/or the cover layer consists of TPE and other thermoplastic polymers. More preferably, the total content of polymers in the intermediate layer and/or the cover layer consists of thermoplastic polymers, i.e., TPE and other thermoplastic polymers such as TPO, and is at least 80 %, most preferably at least 90 %.

Common elastomers include ethylene propylene rubber (EPR), EPDM (ethylene-propylene-diene rubber), ethylene-octene (EO), ethylbenzene (EB), and styrene ethylene butadiene styrene (SEBS). Thermoplastic polyurethane (TPU) is a thermoplastic elastomer consisting of linear segmented block copolymers composed of hard and soft segments.

In the present invention, the terms “elastomer” and “rubber” are used synonymously. They denote polymers that show elastic properties and are crosslinked. They may or may not have a gel content. Their gel content may be between 1 % and 50 %, preferably between 2 % and 50 %, more preferably between 5 % and 50 %.

The rubber may be selected from the group consisting of natural rubber (NR), nitrile butadiene rubber (NBR), hydrogenated nitrile butadiene rubber (HNBR), butyl rubber (IIR), styrene-butadiene rubber (SBR), polybutadiene (BR), ethylene-propylene-diene tripolymer (EPDM), ethylene-propylene rubber (EPR or EPM), silicone rubber, acrylic rubber (ACM), ethylene-vinylacetate copolymer rubber (EVM), polyurethane rubber (PU), and any combination of the above. The rubber can also be a styrene based thermoplastic elastomer (STPE). In particular, the rubber may be selected from the group comprising ethylene/α-olefin copolymer rubber (EAM) as well as ethylene/α-olefin/diene terpolymer rubber (EADM). Preferably the diene in the ethylene-α-olefin-diene rubber is preferably a nonconjugated diene. Suitable nonconjugated dienes include dicyclopentadiene, alkyldicyclopentadiene, 1,4-pentadiene, 1,4 -hexadiene, 1,5 -hexadiene, 1,4 -heptadiene, 2-methyl-1 ,5-hexadiene, cyclooctadiene, 1,4-octadiene, 1,7-octadiene, 5-ethylidene-2-norbornene, 5-n-propylidene-2-norbornene, and 5-(2-methyl-2-butenyl)-2-norbornene. In preferred embodiments, the rubber component comprises an ethylene-α-olefin-diene rubber. The ethylene-α-olefin-diene rubber may comprise an α-olefin having 3 to 8 carbon atoms. The α-olefin in an EAM or EADM rubber is preferably propylene; in such a case the rubber is referred to as EP(D)M. Here, EPM may also be referred to as EPR. It is also possible to use a mixture of the rubbers mentioned above.

In a preferred embodiment of the present invention, the rubber consists of EPDM and EPR. In that case, EPDM preferably constitutes at least 80 % of the total rubber content in the intermediate layer and/or the cover layer. It is preferred that EPDM is contained in a TPV raw material and EPR is contained in a TPO raw material.

EPDM is made from ethylene, propylene and a diene comonomer that enables crosslinking via sulphur vulcanization systems. EPDM contains crosslinks and is preferably fully cured, i.e. crosslinked to an extent of at least 98 %, most preferably to an extent of 100 %. The content of propylene is preferably 45 % to 85 %. Preferred dienes used in the manufacture of EPDM rubbers are ethylidene norbornene (ENB), dicyclopentadiene (DCPD), and vinyl norbornene (VNB). EPDM is preferably crosslinked via vulcanization with sulphur or by using peroxides.

Propylene reduces the formation of the typical polyethylene crystallinity. EPDM is a semi-crystalline material with ethylene-type crystal structures at higher ethylene contents, becoming essentially amorphous at ethylene contents that approach 50 %. EPDM may be compounded with fillers such as carbon black and calcium carbonate, and with plasticizers such as paraffinic oils.

EPR (also referred to as “EPM”) is a random copolymer of ethylene and propylene. EPR is similar to EPDM but contains no diene units. It is crosslinked using radical methods such as peroxides. EPR of different properties can be obtained by varying the monomer ratios. These properties are e.g. viscosity or crystallinity. EPR having from amorphous to semi-crystalline structure can be obtained. EPR preferably comprises 40 to 80 %, more preferably 40 to 60 % of ethylene units. EPR copolymers containing less than about 40 % ethylene generally are known to have poor elasticity at low temperatures, and thus may provide compositions that are too rigid and lack the balance of mechanical properties over a wide temperature range needed for most automotive applications. At high levels of ethylene, generally above about 60 % ethylene units, separate crystalline ethylene domains may form within the rubber component, and interphase adhesion and miscibility are reduced. EPR may be contained in a thermoplastic resin composition in an amount of 10 to 60 %, preferably 15 to 40 %. Resins with less than 10 % of EPR are more rigid and less flexible. The presence of the rubber component at high levels above about 60 % decrease stiffness and tensile strength.

The rubber component contained in the sheet according to the present invention is preferably contained in a thermoplastic vulcanizate (TPV), which can be used as a raw material for producing the intermediate layer and/or the cover layer. TPV as one class of TPE combines the characteristics of vulcanized rubber with the processing properties of thermoplastics. TPV contains rubber particles cured by vulcanization. The rubber particles encapsulated in a thermoplastic matrix.

In the present invention, the rubber particles are made of the rubber described herein, and the thermoplastic matrix is made of TPO described herein. The resin components of TPV may consist of 10-90 parts by weight of the polyolefin resin and correspondingly 90-10 parts by weight of the rubber, preferably 10-80/80-20 parts by weight, and more preferably 30-70/70-30 parts by weight. In the present invention, a TPV based on polypropylene (PP) and EPDM rubber is preferred.

The TPV can either be prepared by mixing the polyolefin with a particulate form of the vulcanized rubber or via a process known as dynamic vulcanization. Dynamic vulcanization consists of intimately mixing a blend of compatible polymers, then introducing a crosslinking system in the mixture while the mixing process is continued. The mechanical performance of TPV improves with the degree of crosslinking of the rubbery phase and with the inverse of the particle size of rubbery domains. TPV can be processed using conventional thermoplastic processes such as injection molding, blow molding and extrusion.

TPV may be compounded with additives. In particular, the TPV may contain different ingredients such as reinforcing fillers (carbon black, mineral fillers), stabilizers, plasticizing oils, and curing systems.

The thermoplastic elastomer may have the shape of particles. The particles are preferably embedded in a matrix of the other polymers present in the layer. The particle size is preferably below 10 μm, more preferably below 1 μm. Preferably, at least 90 % of the particles have a size of less than 10 μm. The size can be determined by scanning electron microscopy (SEM) of a cross section of the layer. The longest diameter of a particle image in an SEM micrograph is defined as its size.

A layer containing the thermoplastic elastomer may additionally contain a thermoplastic polymer, in particular, a thermoplastic polyolefin (TPO) described herein. Examples of blends of rubber with TPO are ethylene propylene diene rubber (EPDM) with polyethylene (PE) and/or polypropylene (PP), blends of ethylene propylene rubber (EPM) with polypropylene (PP) and/or polyethylene (PE) and ethylene propylene blends, and blends of styrene ethylene butadiene styrene (SEBS) with TPO such as polyethylene (PE) and/or polypropylene (PP). A composition may contain elastomers such as EPR or EPDM or SEBS to such an extent and having such a degree of crosslinking that the composition is still thermoplastic.

### Compound Structure

The sheet may contain a compound structure. The compound structure as such is not a layer but is defined by the interaction between the textile layer and the intermediate layer.

Preferably, this interaction is exclusively a physical interaction and excludes chemical interactions such as chemical bonds. The compound structure consists of a part of the textile layer and a part of the contact layer, wherein the contact layer is the intermediate layer consisting of a foam or the lowermost sublayer of the intermediate layer containing a foam layer. The lowermost layer of the intermediate layer may be a compact layer or a foam layer.

In each case, the term “a part” means that the respective layer is not included in the compound structure over the whole thickness direction of the respective layer. In other words, a full interpenetration is excluded, and both the textile layer and the contact layer have a non-interpenetrated layer part in the thickness direction. As a result, the textile layer is not exposed at the A-side of the contact layer surface, and the contact layer is not exposed at the B-side of the textile layer surface.

The compound structure may be characterized by the structure of a cross-section of the sheet perpendicular to the layer plane, as observed with a microscope. The density of the contact layer may be adjusted such that the compound structure is composed of similar ratios of textile layer and contact layer. The compound structure may consist of 30 to 70 % of the textile layer material and 70 to 30 % of the contact layer material. The percentages may be determined on a mass basis or on an area basis by simply determining the respective areas by observing a cross-section of the sheet perpendicular to the layer plane using a microscope.

The process of lamination may be adjusted such that the hollow spaces (which are usually filled with gas such as air) in the textile layer are (almost) completely filled with contact layer composition to obtain a compact compound structure.

The extents of interpenetration are defined as follows: Extent of intermediate layer interpenetration [%]=[(thickness of the compound structure)/(thickness of the contact layer)]×100 %. The thickness of the contact layer is defined as the thickness of the compound structure plus the thickness of the part of the contact layer not being part of the compound structure, i.e., plus the thickness of the contact layer above the compound structure. Extent of textile layer interpenetration [%]=[(thickness of the compound structure)/(thickness of the textile layer)]×100 %. The thickness of the textile layer is defined as the thickness of the compound structure plus the thickness of the part of the textile layer not being part of the compound structure, i.e., plus the thickness of the textile layer below the compound structure.

### Manufacturing Method

The sheet according to the present invention may be prepared by a method comprising the following steps:
(a) providing an intermediate layer composition;
(b) at least partly melting the intermediate layer composition;
(c) forming a laminate of the at least partly molten intermediate layer composition and a support layer containing or consisting of a textile layer such that the intermediate layer composition and the textile layer at least partly interpenetrate each other; and
(d) cooling the intermediate layer composition.

In step (a), the intermediate layer composition may be provided in the form of (i) particles such as granules of an intermediate layer composition or (ii) a finished film containing the intermediate layer composition.

In the case of (i), step (b) comprises melting the particles of the intermediate layer composition, preferably using an extruder. The intermediate layer may be applied after step (d) to obtain the sheet. In the case of (ii), step (b) comprises heating the film at least on one side to at least partly melt the intermediate layer composition contained in the film. The intermediate layer composition may be selected to have a melting temperature that is lower than the melting temperature of the textile layer of the support layer. Thus, the molten intermediate layer composition penetrates the hollow spaces of the support layer without melting the fibers of the support layer. In that case, the intermediate layer and the support layer can be separated from each other by heating. Alternatively, the intermediate layer composition may be selected to have a melting temperature that is equal to or higher than the melting temperature of the support layer and that stands the temperature of the molten intermediate layer when in contact with it. Thus, the intermediate layer composition at least partly melts the fibers of the support layer when penetrating the hollow spaces. In that case, the intermediate layer and the support layer are more strongly bonded to each other. In the case of (ii), the cover layer may be applied after step (d) or may be layered at the rear side of the film containing the intermediate layer composition.

In step (c), the laminate forming is carried out preferably using an extruder in the case of (i). The molten intermediate layer composition may be extruded and applied onto the support layer, or the molten intermediate layer composition may be extruded onto a carrier and the support layer may be applied onto the intermediate layer composition. In both cases, the intermediate layer composition, the support layer, and the process conditions have to be selected such that the intermediate layer and the support layer interpenetrate each other to a desired extent. If pressure is applied in forming the laminate, the support layer is compressed thus enabling an easier and deeper penetration by the molten intermediate layer composition. As a result, the adhesion between the support layer and the intermediate layer may be stronger.

1-15. (canceled)

16. A sheet, comprising:
a support layer containing a textile layer having at least one fiber selected from the group consisting of polyester, polyolefin, polyamide, polyurethane, cotton and other natural fibers;
an intermediate layer disposed on said support layer, said intermediate layer being a foam layer or containing a foam sublayer, wherein said support layer is directly bonded to said intermediate layer and no adhesive layer is disposed between said support layer and said intermediate layer, wherein said textile layer of said support layer is directly bonded to said intermediate layer, wherein said foam layer or said foam sublayer of said intermediate layer that is directly bonded to said support layer contains a thermoplastic elastomer; and
a cover layer disposed on said intermediate layer, wherein said cover layer is a compact layer, wherein at least one of said intermediate layer or said cover layer contains said thermoplastic elastomer.

17. The sheet according to claim 16, wherein said intermediate layer contains a compact sublayer and said foam sublayer.

18. The sheet according to claim 16, wherein said foam layer or each said foam sublayer of said intermediate layer contains said thermoplastic elastomer.

19. The sheet according to claim 16, wherein said foam layer or each said foam sublayer of said intermediate layer contains said thermoplastic elastomer and wherein said cover layer contains said thermoplastic elastomer.

20. The sheet according to claim 16, further comprising a compound structure consisting of only a part of said textile layer and only a part of said intermediate layer interpenetrating each other.

21. The sheet according to claim 16, further comprising a compound structure consisting of a part of said textile layer and a part of said intermediate layer interpenetrating each other, wherein and extent of a textile layer interpenetration, defined as [(thickness of the compound structure)/(thickness of the textile layer)]×100 %, is 5 % to 90 %, the thickness of said textile layer being the thickness of said compound structure plus a thickness of said part of said textile layer not being part of said compound structure.

22. The sheet according to claim 16, wherein:
said support layer is said textile layer which has a thickness of 0.1 to 2.0 mm;
said intermediate layer has a thickness of 1.0 to 5.0 mm; and
said cover layer has a thickness of 0.1 mm to 1.5 mm.

23. The sheet according to claim 16, wherein the sheet is an artificial leather sheet.

24. A method of preparing a sheet, containing:
a support layer containing a textile layer having at least one fiber selected from the group consisting of polyester, polyolefin, polyamide, polyurethane, cotton and other natural fibers;
an intermediate layer disposed on the support layer, the intermediate layer being a foam layer or containing a foam sublayer, wherein the support layer is directly bonded to the intermediate layer and no adhesive layer is disposed between the support layer and the intermediate layer, wherein the textile layer of the support layer is directly bonded to the intermediate layer wherein the foam layer or the foam sublayer of the intermediate layer that is directly bonded to the support layer contains a thermoplastic elastomer; and
a cover layer disposed on the intermediate layer, wherein the cover layer is a compact layer, wherein at least one of the intermediate layer or the cover layer contains said thermoplastic elastomer;
the method comprises the step of:
thermally or thermo-mechanically bonding the support layer, the intermediate layer, and the cover layer.

25. A sewn product, comprising:
providing said sheet according to claim 16, wherein the sheet is a sewn sheet.

26. A method of preparing a sewn product, which comprises the steps of:
providing the sheet according to claim 16; and
sewing the sheet together.

27. A production method, which comprises the steps of:
providing the sheet according to claim 16; and
using the sheet as a material in an interior of a vehicle.
